(19) United States
(12) Patent Application Publication
(10) Pub. No.: US 2025/0266906 A1
(43) Pub. Date: Aug. 21, 2025

(54) OPTICAL APERTURE FOR MODULATING RETROFLECTING OPTICAL COMMUNICATION, POSITIONING, AND TIMING

(71) Applicant: California Institute of Technology, Pasadena, CA (US)

(72) Inventors: Lin Yi, Pasadena, CA (US); Jeremy Schumacher, Pasadena, CA (US); Subrahmanya V. Bhide, Pasadena, CA (US)

(73) Assignee: California Institute of Technology, Pasadena, CA (US)

(21) Appl. No.: 19/058,955

(22) Filed: Feb. 20, 2025

Related U.S. Application Data
(60) Provisional application No. 63/555,792, filed on Feb. 20, 2024.

(51) Int. Cl. H04B 10/112; G02B 5/124; H04B 10/50

(52) U.S. Cl. CPC H04B 10/1123; G02B 5/124; H04B 10/503

(57) ABSTRACT

A device including an optical aperture comprising a plurality of outwardly facing modulating retroreflectors (MRR) disposed at a same radius about a center point; wherein each of the MRRs comprises a plurality of reflectors coupled to a modulator. A number and arrangement of the reflectors is configured to enable positioning of the aperture from a ranging measurement of a coordinate of the modulator using retroreflections of laser beams back to at least one base station after transmission from the at least one base station and when the aperture is attached to an airborne or spaceborne unmanned vehicle.

### CROSS REFERENCE TO RELATED APPLICATIONS

This application claims the benefit under 35 U.S.C. Section 119 (e) of U.S. Provisional Application No. 63/555,792, Feb. 20, 2024, by Lin Yi, Jeremy Schumacher, and Subrahmanya V. Bhide, entitled “Optical Aperture for Modulating Retroflecting Optical Communication, Positioning, and Timing,” which application is incorporated by reference herein.

### STATEMENT REGARDING FEDERALLY SPONSORED RESEARCH AND DEVELOPMENT

This invention was made with government support under Grant No. 80NMO0018D0004 awarded by NASA (JPL). The government has certain rights in the invention

### BACKGROUND OF THE INVENTION

### Field of the Invention

The present disclosure relates to optical apertures useful in phased arrays and methods of using and making the same.

### Description of the Related Art

Interferometric antenna arrays using scalable distributed platforms, such as a swarm of unmanned aerial vehicles (UAVs) and CubeSats, may provide a low-cost and flexible solution for communications and remote sensing applications. The dynamic motions of these platforms pose a significant challenge to maintaining the required phase coherence between the array nodes [1]. A simplified phase noise assumption shows that the antenna gain can retain up to 90% if the relative positions of the array nodes can be determined within 1/15 of the operating wavelength [2]. Such a phase-coherent distributed interferometric antenna array with a large number of array nodes typically relies on the GNSS to determine the relative positions and timing, which may limit the highest operating frequency and eventually the communication data and remote-sensing resolution. Point-to-point cross-links with microwave (e.g. Ka-band) and optical frequencies are capable of providing the required ranging resolution, but the complexity of the linking architecture increases rapidly with a large number of array nodes. In addition, high-precision ranging requires pointing the beams with high precision, which may be challenging for the UAV and CubeSat platforms.

In recent years, stepped-quantum-well (SQW) modulating retroreflectors (MRRs) have shown ultra-low power consumption [3] in the architecture of retro-reflecting optical communications for short-distance applications [4] [5]. What is needed however, are more accurate methods for synchronizing the nodes in the array. The present disclosure satisfies this need.

### SUMMARY OF THE INVENTION

The present disclosure describes a method and system for synchronizing a network of unmanned vehicles (UAVs). Each of the vehicles are attached to an optical aperture comprising a plurality of modulating retroreflectors (MRRs) disposed at the same radius about a center point of the aperture, wherein each of the modulating retroreflectors comprises a plurality of reflectors coupled to a modulator. The unmanned vehicles may each further comprise sensors or other functional devices for synchronous operation of network.

In order to synchronize the network, the system further comprises one or more base stations and a computer system for performing a rangefinding measurement of a center point of the apertures. For this purpose, each of the base stations comprise a laser source for emitting a laser beam irradiating the apertures, and a receiver for receiving a modulated reflection of the laser beam from one or more of the MRRs. The computer system then calculates the position of the center point from the ranging measurement of a coordinate of the modulator using the modulated retro-reflection if laser beam and outputs a timing signal for synchronizing the unmanned vehicles.

In one embodiment, a timing synchronization algorithm and an associated mission concept uses a swarm of unmanned aerial vehicles (UAVs) to form a large distributed interferometric antenna in the frequency range of 0.1 to 20 GHz. The algorithm is customized to passive optical communications between multiple ground laser interrogating terminals and the UAVs with stepped quantum-well modulating retroreflecting devices. The mission concept allows a large number of UAVs to be used as distributed interferometric nodes and identified (via different local modulating frequencies) by a small number of ground terminals, eliminating the complexity of a large number of one-on-one optical links in this scenario.

The system was theoretically characterized for plurality of designs to determine design limitations on ranging/timing errors and data rate. The simulation calculates position and attitude of the UAV mounted with several quantum-well devices in a series of optical aperture designs (ranging from 6-face to 60-face configurations). For a 0.1 m full optical aperture with the 60-faces, the geometric introduced positioning error is as low as 2.3 micrometers (76 fs in timing). Considering other systematics can cause pico-second level timing errors, we estimated the antenna's maximum operating frequency is about 20 GHz. Also disclosed are analytic studies of the maximum receiving communication data rate allowable with the distributed antenna for the different optical aperture designs.

In another embodiment, the base station is a main orbiter and the unmanned vehicles are satellites. Simulations show sufficient data rates between the satellites and the main Orbiter for separation distances as large as 10000 km. Operational lifetime analysis estimates 80-200 days with a single battery.

The disclosure further describes experimental demonstration of a spinning testbed to verify the field of view of the MRRs.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. Referring now to the drawings in which like reference numbers represent corresponding parts throughout:

FIG. 1: A mission concept for distributed interferometric antenna using UAVs and laser-based ground terminals.

FIG. 2A-2B: A schematic showing the working principle of the Modulating Retroreflector (MRR) [4], wherein FIG. 2a is a side view and FIG. 2b is a perspective view.

FIG. 2C. A schematic of rotation of the aperture and methodology for measuring center point of the aperture.

FIG. 2D. A schematic illustrating mounting of the MRRs on a framework.

FIG. 2E illustrates an example stepped quantum well modulator.

FIG. 2F illustrates example performance of the modulator (modulation vs. Applied voltage).

FIG. 2G: Schematic illustrating the primary source of error for time synchronization caused by variations in the distance a ray travels in different retroreflector designs (difference in channel size, angle of impact, and position at which the ray intersects the channel).

FIG. 3A: Raytracing between ground station and UAVs.

FIG. 3B: Comparison in the Error due to Geometric Variation with and without the Algorithm (Apothem of UAV is 0.1 m and using 6 sided reflector). For each position determine how many channels will reflect at least 1 ray (that goes through the modulator).

FIG. 4: Plot Depicting the Relationship between the Size of the MRR and the Error in Calculating the Center Position and Orientation

FIG. 5: Plot Depicting the Relationship between the Number of Faces on the MRR and the Error in Calculating the Center Position and Orientation.

FIGS. 6A-6E. Models of each of the different MRR designs along with a plot depicting the three dimensional (3D) coverage projected onto a spherical surface around the MRR, for octahedron (FIG. 6A), subdivided octahedron (FIG. 6B), double subdivided octahedron (FIG. 6C), icosahedron (FIG. 6D) and subdivided icosahedron (FIG. 6E), plotting number of faces reflecting rays given the position of the ground station relative to the octahedron or icosahedron retroflector, wherein the distance between ground station and Appothem is 10m-100m.

FIG. 7A: Schematic showing reflection of a laser beam from the MRRs.

FIG. 7B: Comparison between the different retroreflector models and the coverage they yield.

FIG. 8: Variation of the data rate achievable using a single MRR and a corresponding laser source separated by a distance of 10 km with the Input power i.e. incident laser power at the MRR.

FIG. 9: Variation between Base data rate and beam waist for a subdivided icosahedron.

FIG. 10. Variation between Laser beam spread and beam waist for a subdivided icosahedron.

FIG. 11. Mission concept utilizing expendable Chat-orbiters—small CubeSats featuring modulating retroreflectors and ultra-low power stepped-quantum-well modulators. The main Orbiter, equipped with a laser communication

FIG. 12. Data rate variation with range.

FIG. 13. Required power variation with range.

FIG. 14A-14B. Double-pass retro-reflector array setup

FIG. 15. Reflected power via icosahedral array, 38 deg/s

FIG. 16. Double-pass AOM MRR setup.

FIG. 17. Results for Modulating the AOM MRR during rotation.

FIG. 18. Example hardware environment.

FIG. 19. Example Network environment.

FIG. 20. Example method of assembly.

FIG. 21. Example method of operation.

FIG. 22. Example timing algorithm.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

### Example Systems

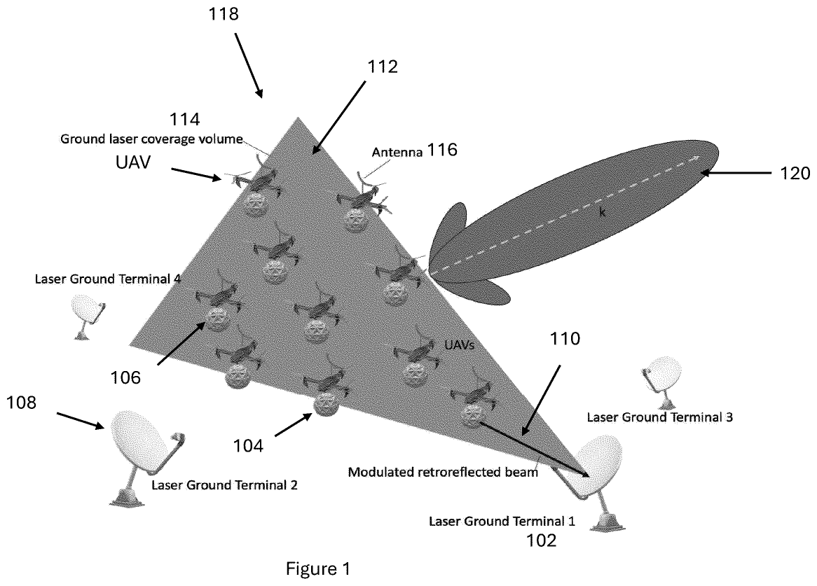

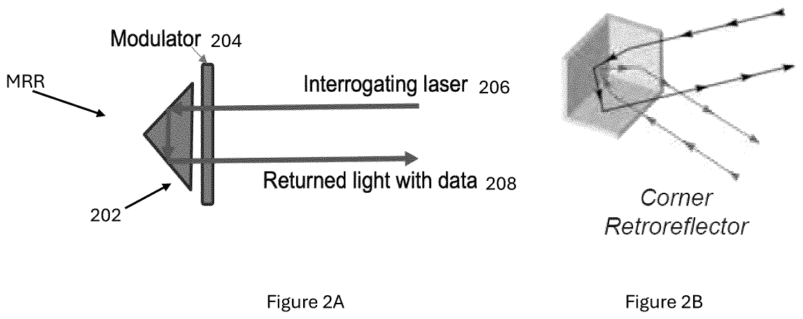

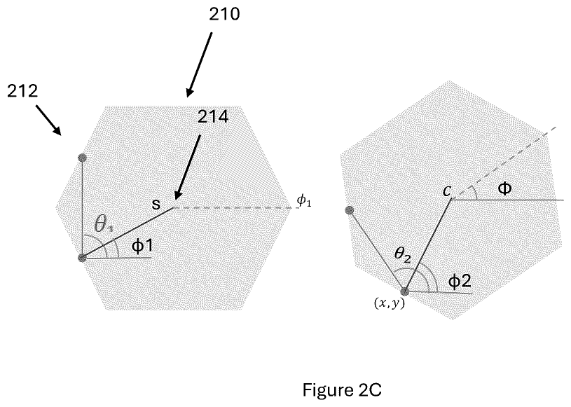

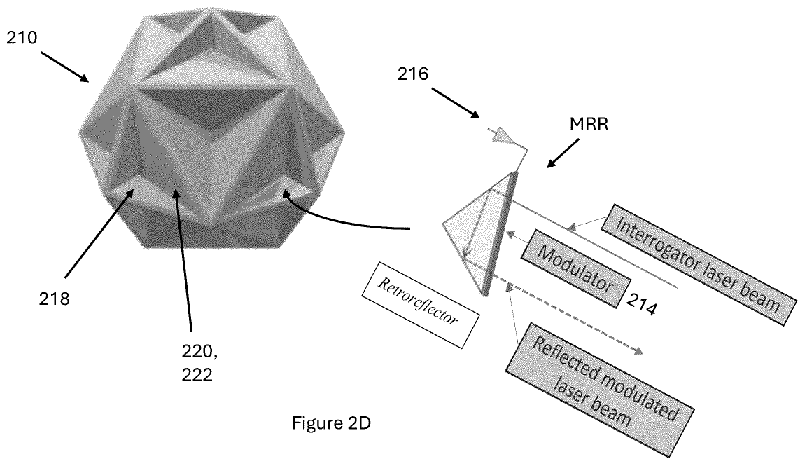

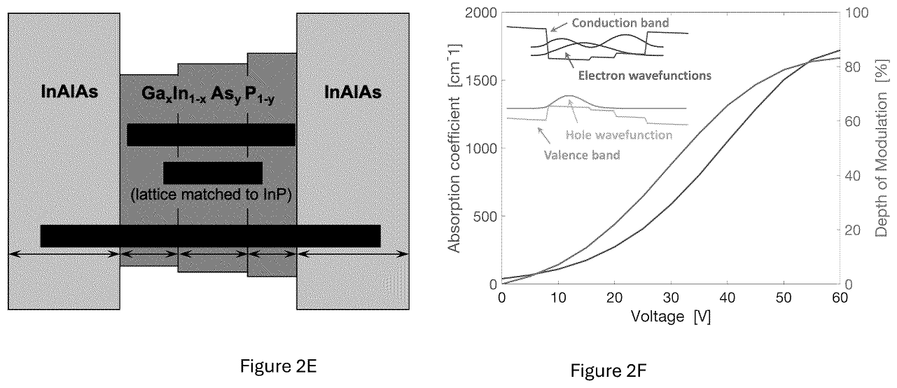

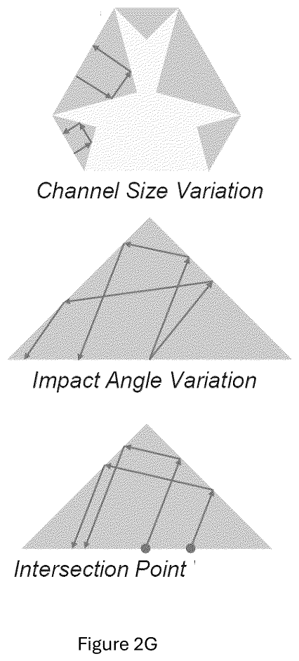

FIG. 1 illustrates an example swarm consisting of a plurality of UAVs flying at a particular altitude with a plurality of ground-based laser stations 102 located at the 4 corners of a square of which the UAV swarm is at the center (as seen from the zenith). Each UAV of the swarm is modeled as having a multifaced body (an aperture 104) with Modulating Retroreflectors (MRR) placed on each face 106 (or positioned relative to one more faces 106 of the body). FIGS. 2A-2B illustrate the MRRs are retroreflectors comprising reflectors 202 coupled to a modulator 204 with a capability to modulate the incoming beam 206 (interrogating laser) and reflect it as return light 208 with data. FIGS. 2C and 2D illustrate the aperture 104 comprises a geodesic polyhedron 210 and the MRRs are each disposed at a different side 212 about the center point 214. A number and arrangement of the reflectors is configured to enable positioning of the center point from a ranging measurement of a coordinate of the modulator, using the retroreflections when the aperture is attached to the unmanned (airborne or spaceborne) vehicle. FIG. 2D illustrates an example wherein the geodesic polyhedron comprises a mounting framework (e.g., comprising 3D printed polymer) for the MRRs (e.g., comprising glass inserts), wherein the framework comprises a plurality of insert holes 218, defined by the facets 220 or facet subdivisions 222 of the polyhedron, into which the MRR are seated. In this way, the MRRs are disposed facing outwardly on the surface of the optical aperture and about the center point 214, and the number and arrangement of subdivisions 222 each comprising a reflector 202 in one of the MRRs can be tailored for various performance metrics such a predetermined data rate or robustness in terms of reliability in reflecting the laser beam (e.g., view factor).

Recent advancements in passive optical wireless communication, particularly through ultra-low power stepped-quantum-well modulators, enhance the effectiveness of these interferometric arrays ([6] in paragraph 191). Stepped Quantum Well (SQW) modulators utilize the quantum-confined Stark effect to achieve high electro-optical coupling within compact interaction lengths ([3] in paragraph 191). Advanced simulation techniques enable the precise design of the epitaxial layers of these modulators to ensure optimal performance with the specified driving voltage and modulation depth. This customization results in reduced power consumption for a given data transmission rate. Consequently, SQW modulators can be engineered for applications such as remote optical tagging, achieving data transmission rates exceeding 1 Gbps while consuming only a few pJ/bit. The MRR-based optical transceivers on the platforms eliminate the need for active laser sources and precision laser pointing systems on each individual spacecraft, thus reducing their power consumption and mass. This strategic design allows the unmanned vehicle platforms to focus on their objectives without the burden of complex communication systems. FIG. 2E illustrates an example stepped quantum well modulator. FIG. 2F illustrates example performance of the modulator, illustrating 5% modulation depth, 89% transmission, for 5V voltage swing. For 1 mm size and 10 MHz modulation frequency, the expected power consumption is 2.76 mW.

As illustrated in FIG. 1, each ground-based laser station 102 consists of a laser source with sufficient power that a collector 108 may receive the modulated retroreflected laser beams 110 reflected off of the different faces of the UAVs. The multifaced UAVs can have different designs with different numbers of faces, and the system is typically configured to transmit a beam 112 in a laser coverage volume 114 encompassing all of the UAVs in the swarm and to subsequently receive reflection off of the MRRs on the UAV faces. The reflected laser beam which is modulated by the MRR is used for data transfer and further ranging and time transfer functionalities. As illustrated n FIG. 1, at least 4 ground stations are each positioned to irradiate all of the unmanned vehicles with the laser beam, such that a 4D coordinate (3 spatial coordinates and one time coordinate) can be computed using the coordinate obtained using the laser beam transmitted from each of ground stations (similar to a global positioning system technique). The optical receiver comprises an electronic circuit 216 for driving the modulator on different ones of the unmanned vehicles to impart a unique modulation to the beam that allows identification of the center point on the different unmanned vehicles by the ranging measurement, as illustrated in FIG. 2D).

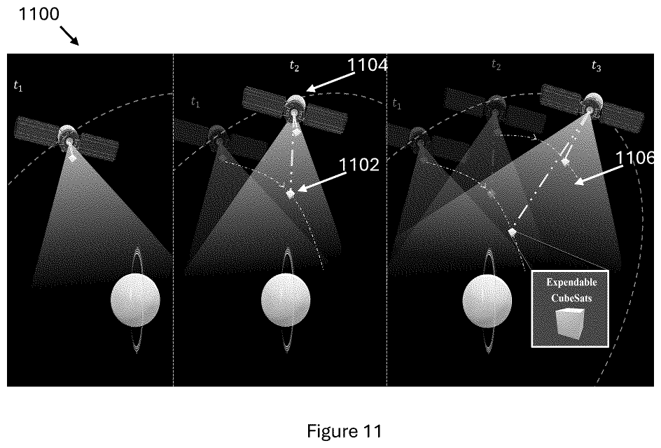

Although FIG. 1 illustrates the system using UAVs, the system can be generalized to the use of unmanned vehicles generally, including but not limited to satellites (e.g., CubeSats as illustrated in FIG. 11) and drones. FIG. 1 illustrates an example wherein the UAV is equipped with an antenna 116 for emitting an electromagnetic field (e.g., radio frequency field), such that when the UAVs are properly synchronized in an interferometric or phased array 118, the array emits a directed beam 120. In other embodiments discussed herein (see, for example FIG. 11), the unmanned vehicles are equipped with sensors or sensor systems that can be used to perform remote sensing. Moreover, the ground stations can be replaced with airborne or spaceborne base stations.

### Time Synchronization Analysis and Simulation

Determining the center position of the MRR poses a significant challenge for the time synchronization algorithm as the geometric configuration of the MRR introduces variability in the calculated center position, as shown in FIG. 2E, thereby impacting the precision of the time synchronization algorithm. To determine the center position and orientation of the MRR more accurately, an algorithm was developed.

The algorithm begins by analyzing key characteristics of the MRR in its initial state. It calculates the average distance traveled by a signal within each reflector channel and determines the orientation of the midfaces. These midfaces are imaginary planes intersecting the midpoint of the exterior faces of three channels, where the modulator is situated. The algorithm establishes a relationship between the midpoint of each exterior face and the center position using a spherical coordinate system centered at the midpoint.

Upon determining these initial properties, the center position can then be determined when the MRR is in an alternate orientation. More specifically, quantum well modulators on the MRR modulate the signal transmitted from the ground stations, each of the MRRs imparting a unique modulation that allows identification of the channel it interacts with. By precisely measuring the signal's travel distance and the angle of the reflected signal, the algorithm can determine the position of the modulator.

To find the orientation of a midface, the positions of three or more quantum well modulators are found. This information assists in calculating the pitch, yaw, and roll of the MRR in its new orientation. Once the rotation of the retroreflector is known, the algorithm estimates the center point's position using the initial relationship established between each quantum well modulator and the MRR's center position.

To assess the algorithm's performance, a 2D simulation using MATLAB compares the error with and without the algorithm. In this simulation, the following equation is used to determine the position of the quantum well modulators:

$$\vec{{p}_{ι}} = \vec{{p}_{g}} + \frac{d - {r}_{i}}{2 [ cos ( θ ) , sin ( θ ) ]}$$

where \vec{pᵢ} represents the estimated position of the quantum well modulator, \vec{p_{g}} is the position of the laser ground station, d is the total distance the signal travels, rᵢ is the average distance the signal travels in the i^{th} MRR channel, and θ is the angle the signal is sent out at.

In the 2D scenario, pinpointing two quantum well modulator positions is sufficient. This reveals the midline's (the line that intersects two quantum well modulators) orientation and, consequently, the MRR's orientation in its new position. FIG. 2c shows how the center position 214 of the MRR can be estimated using:

$${c}_{i} = {p}_{i} + {s}_{i} [ cos ( {ϕ}_{i} + Φ ) , sin ( {ϕ}_{i} + Φ ) ]$$

where cᵢ is the estimated center position 214 of the retroreflector based on the i^{th} quantum well modulator, \vec{p}ⁱ is the estimated position of the quantum well modulator, sᵢ is the distance between the i^{th} modulator retroreflector and the center 214 of the retroreflector, ϕi is the angle of elevation from the i^{th} quantum well retroreflector to the center of the retroreflector in the initial state, and Φ is the angle of rotation of the retroreflector=ϕ1−ϕ2, where ϕ1 and ϕ2 are angles of elevation at two different orientations of the aperture.

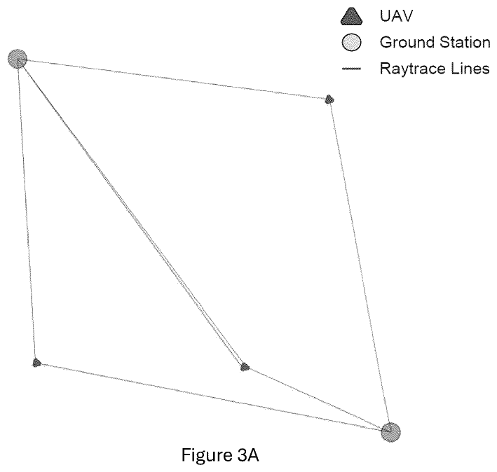

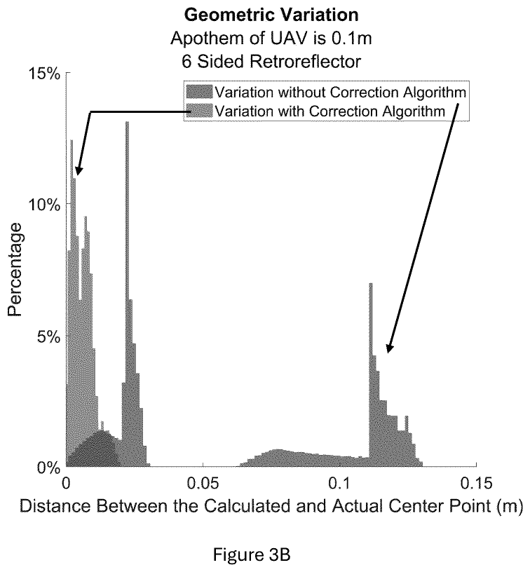

The simulation's analysis is depicted in FIG. 3, illustrating that the correction algorithm reduces the variation between the calculated center position and the actual center position by approximately 85%.

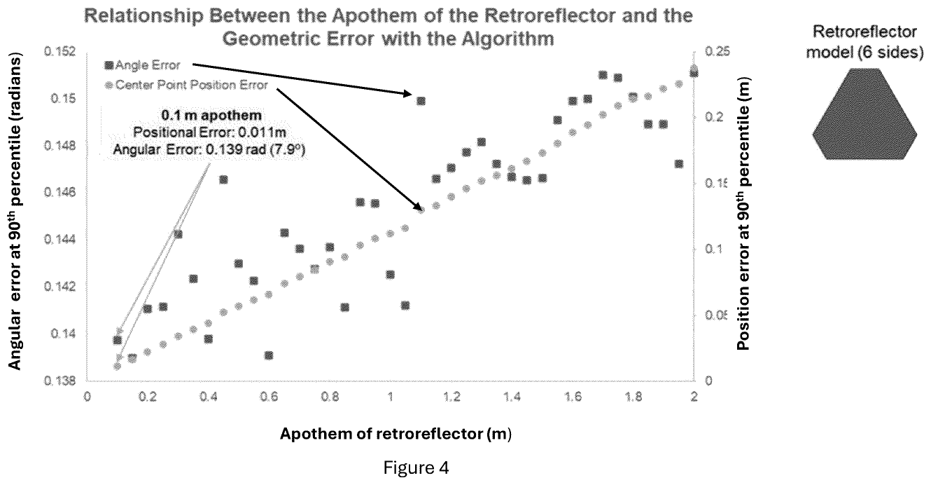

The impact of various geometric variables on the algorithm's performance was investigated theoretically. FIG. 4 shows how the size of the retroreflector influences the algorithm's performance. An increase in the retroreflector's apothem from 0.1 m to 2 m was observed, and we note a relatively constant angular error ranging from 0.138 radians to 0.152 radians. However, the positional error demonstrated a direct proportionality to the retroreflector's apothem.

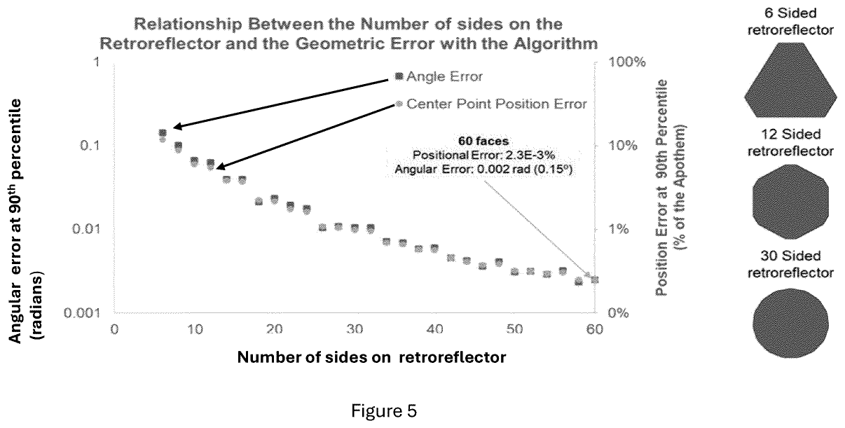

FIG. 5 shows the influence of the number of faces (on the retroreflector) on the algorithm's performance. The analysis reveals that increasing the number of sides on the retroreflector leads to both angular and positional errors asymptotically approaching zero.

### Simulation of Different MRR Design Geometries

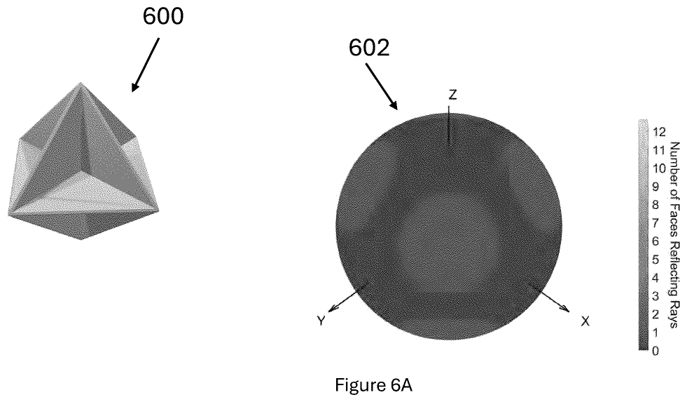

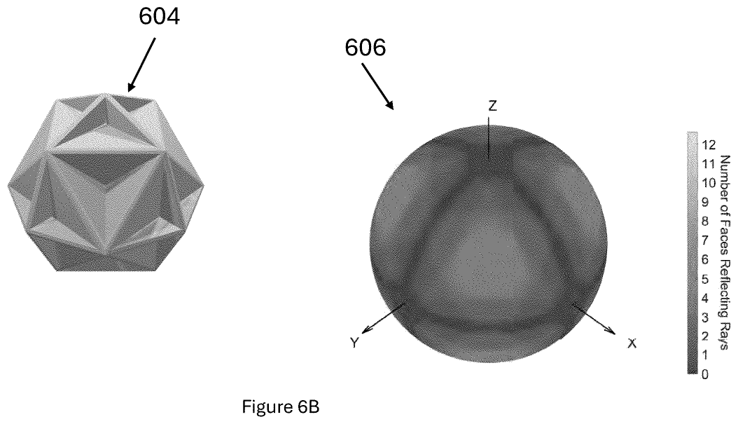

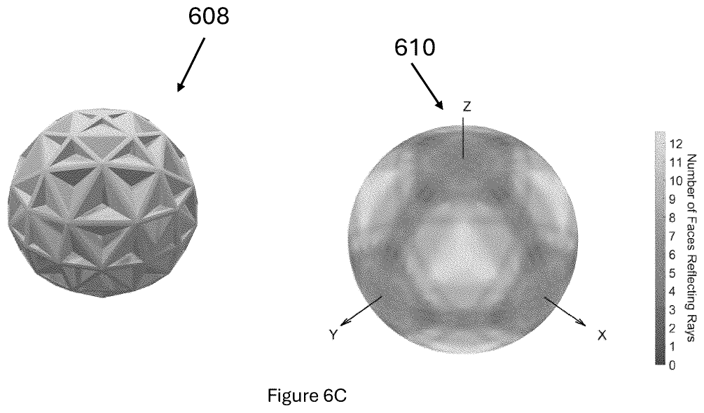

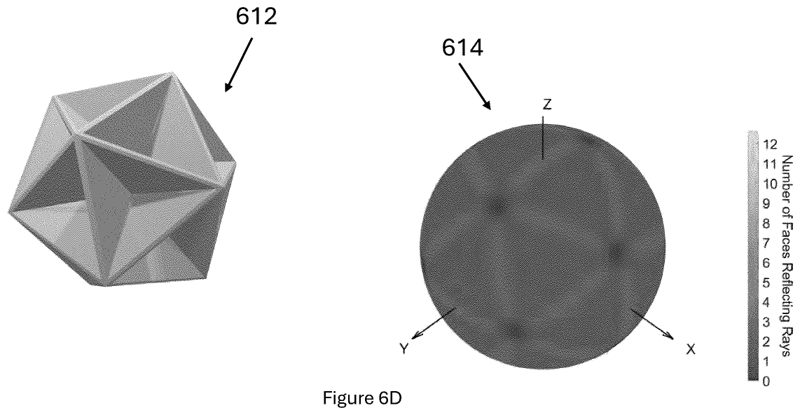

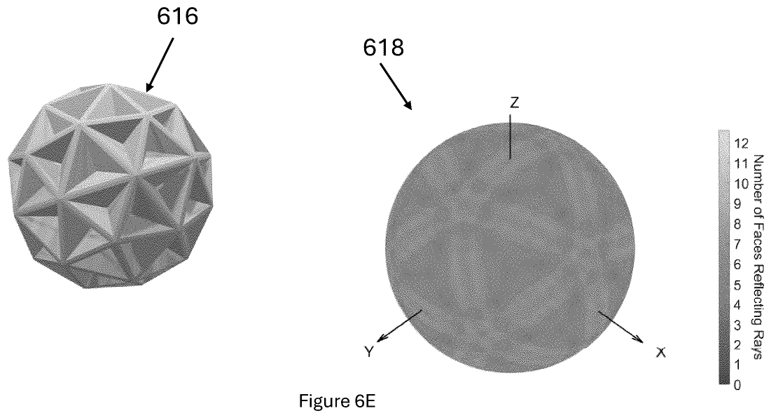

The consistency of reflecting a signal to the laser ground station was analyzed for different retroreflector geometric designs. The analysis uses MATLAB code to place multiple laser ground stations around the retroreflector. For each station position, the program finds that channels of the retroreflector are able to reflect a signal toward the position it was emitted from. In each of the FIGS. 6A-6E, the optical aperture shape (octahedron 600, 604, 608 or icosahedron 612, 616) with facets is shown on the left side of the figure with the corresponding coverage (602, 606, 610, 614, 618) shown on the right hand side of the figure.

The first design is based on an octahedron 600 (FIG. 6A), an 8-faced polyhedron. The plot illustrating the coverage projected onto a spherical surface 602 reveals poor performance. Simulations show that, approximately 20% of the time, one face can reflect a ray, while the remaining 80% of the time, no faces are able to reflect a signal toward the ground station.

The subsequent design retains the octahedron shape with each face subdivided and smoothed to resemble a sphere, resulting in a 32-sided spheroid 604 (FIG. 6B). The coverage 606 significantly improves, with only 30% of instances having no faces capable of reflecting a ray. In 50% of cases, one or two faces could reflect a ray, and in the remaining 20%, three or more faces were effectively able to reflect a ray toward the laser ground station. The subsequent design 608 comprises further subdivision of the facets, as shown in FIG. 6C, resulting in exponential improvement of the coverage 610. In this case, every position on the surface had at least three faces capable of reflecting a ray. However, the analysis of this retroreflector shows that there were still regions where coverage was poor (specifically along the XY, XZ, and YZ planes).

FIG. 6D illustrates a design based on an icosahedron 612. This design has better coverage 614 than the initial octahedral design, but the simulation shows there are still regions where no channels were able to reflect a ray toward the laser ground station. Subsequently, we simulated the effect of subdividing the icosahedron 616 (FIG. 6E), increasing the number of faces. This design shows promising results, ensuring that every position had three or more reflected rays. It has fewer faces than the doublesubdivided octahedron but offers more consistent coverage 618.

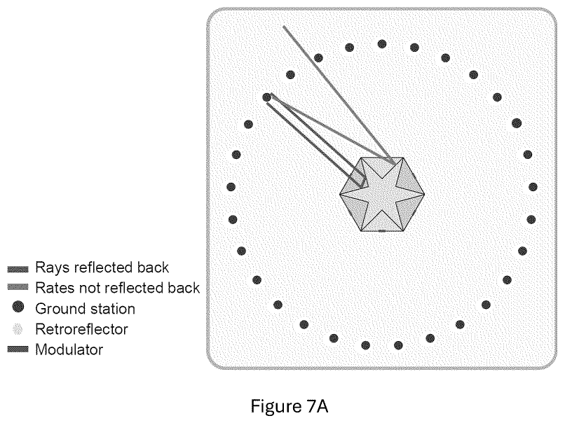

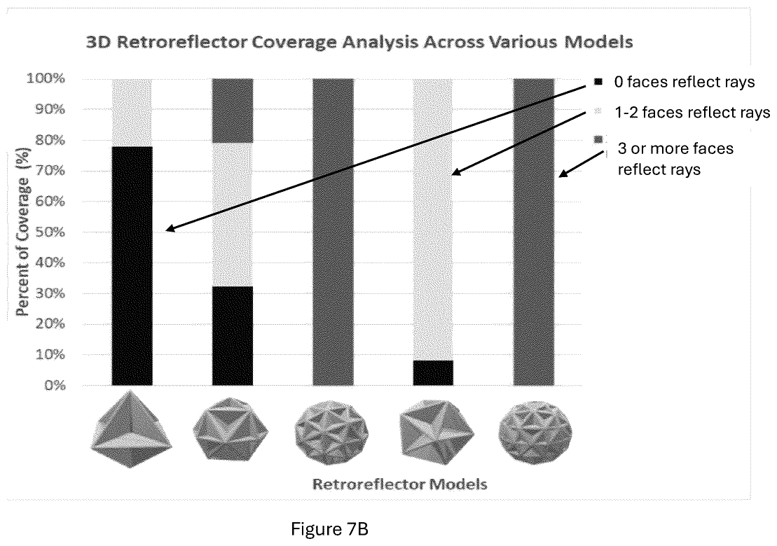

A direct comparison between different retroreflector models is illustrated in FIG. 7. The octahedral design exhibits the poorest coverage, while the doublesubdivided octahedral and the single-subdivided icosahedral demonstrate the most extensive coverage.

### Communication and Data Rate Analysis

The communication data capabilities are studied in two parts. We define a number as the View Factor between the UAV and the ground Laser station, wherein the view factor is the fraction of time any MRR of the UAV is in contact with the laser beam source (e . . . g, making data transfer possible). We consider different UAV designs with different numbers of MRRs (faces) and different kinds of MRRs (Cats eye and Corner cube). Cats Eye and Corner Cube essentially differ in the angular field of view. The presence or absence of contact is determined by comparing the angle between the normal vector to the MRR and the laser ray to the MRR with the field of view. We also simulate periods of low-frequency sinusoidal oscillations with a maximum value being the corresponding average angular deviation obtained from experiments detailed in the following sections. These oscillations have been provided about the pitch and roll axes of the UAV. The results of the simulation are summarized below:

TABLE 1
Comparison of View Factors between Cats Eye and
Corner Cube configuration with different faces

| View Factors for different | Cats Eye | Corner Cube |
|---|---|---|
| retroreflectors and MRR | Retroreflector | retroreflector |
| combinations | (10 deg) | (35 deg) |
| Subdivided Icosahedron | 2 | 15 |
| Subdivided Octahedron | 2 | 2 |
| 2X SubdividedOctahedron | 2 | 10 |
| Icosahedron | 2.8828 | 3 |
| Octahedron | 1.9389 | 4 |

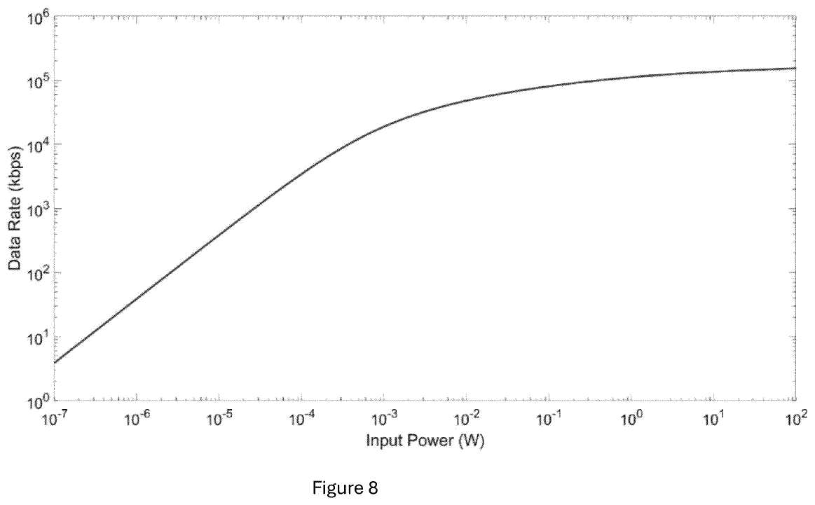

We also calculate the data rate between a laser source and a single MRR kept at a particular distance from each other (for use as a baseline and for further calculations). All the simulations are performed using the UAV design detailed above with an apothem of 0.1 m). FIG. 8 shows the results of the calculations for the data rate following [3].

For the laser source calculations, we assume a Gaussian beam to find out the incident power on the MRR. From this, the base data rate and subsequent calculations can be obtained. For a Gaussian beam, we have the following relations:

$${z}_{R} = \frac{π {w}_{0}^{2}}{{M}^{2} λ}$$

$${w ( z )}^{2} = {w}_{0}^{2} [ 1 + {( \frac{z}{{z}_{R}} )}^{2} ]$$

$$P ( z ) = {P}_{0} \frac{Area ( MRR )}{4 π {r ( z )}^{2}}$$

where, z_{R} is the rayleigh distance, w₀ is the beam waist, M is the laser quality factor which is 1 for Gaussian beams, λ is the wavelength of the laser, w(z) is the beam width at a distance of z, and P₀ is the laser power.

TABLE 2
Data rates for different apertures and MRR configurations
for a laser power of 10 W separated at a 10 km distance.
In one or more embodiments, total data rate = basic
data rate × view factor × number of UAVs × 4.

| | Number of | | Basic | Total data | Total data | Data rate |
|---|---|---|---|---|---|---|
| | channels | | data | rate in | rate in | per UAV |
| | (total area | | rate in | Gbps (50 | Gbps (200 | per sq cm |
| UAV shapes | in sq cm) | | Mbps | UAVs) | UAVs) | in Mbps |
| Octahedron | 20 | (76) | 35.57 | 13.52 | 54.1 | 3.558 |
| Subdivided | 80 | (36) | 26.1 | 10.44 | 41.76 | 5.8 |
| Octahedron | | | | | | |
| 2X | 128 | (10) | 11.96 | 4.784 | 19.13 | 9.57 |
| Subdivided | | | | | | |
| Octahedron | | | | | | |
| Icosahedron | 8 | (40) | 27.43 | 15.8 | 63.2 | 7.9 |
| Subdivided | 32 | (12) | 13.67 | 5.46 | 21.84 | 9.1 |
| Icosahedron | | | | | | |

The results obtained have been tabulated in Table. 2. These calculations assume a beam quality of 1 (Gaussian), a beam waist of 1 mm resulting in a beam waist at 10 km to be ˜5 m, and a laser power of 10 W. With an M>1, we would obtain increased data rates, but we restrict ourselves to Gaussian beams for this study. The channels referred to in Table 2 are the number of faces or equivalently the number of MRRs on the UAV.

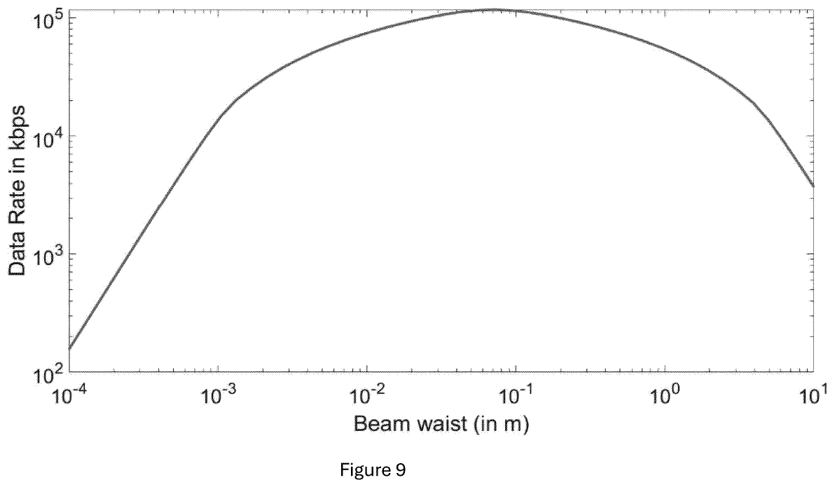

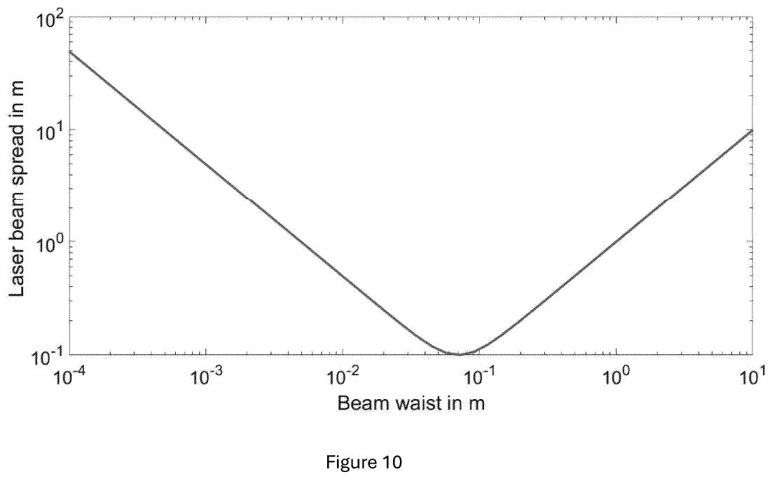

Since the data rates are a function of the UAV face area, the Data Rate per UAV per unit is an important metric helping us understand the different UAV structures (also has been provided in Table 2). Based on this metric we find that the 2×Subdivided Octahedron with the largest number of channels is the better structure of all the structures studied in terms of data rate per square cm on the optical terminal surface (leading to the size of the optical terminal). However, the laser beam spread, and hence the incident radiation changes with the beam waist. This leads to different base data rates. Also with different beam spreads the number of UAVs that can be accommodated in the swarm varies. The variations are shown in FIGS. 9 and 10. Thus there exists optimal beam waists that could lead to an optimal total data rate for the UAV swarm.

As the number of channels in the UAV increases, the area of the MRR faces reduces and so does the incident power. This also leads to variations in the data rate. The data rate is a function of beam waist, separation distance between the laser source and the UAV, field of view, and surface area of the MRR and the UAV structure themselves. With this, an optimization problem can be formulated and constraints on different parameters can be imposed for different applications.

### Chat Orbiter Embodiment

FIG. 11 illustrates an example system 1100 comprising plurality of unmanned vehicles 1102 each attached to a receiver comprising an optical aperture comprising a plurality of modulating retroreflectors (MRRs); a sensor or transceiver system configured for transceiving signals; and a base station 1104 comprising a laser for transmitting a laser beam 1106 having a size irradiating the unmanned vehicles, and a receiver for receiving a modulated reflection of the laser beam from one or more of the MRRs. As discussed herein, the system is further coupled to a computer system programmed for calculating the position of the center point of the aperture from a ranging measurement of a coordinate of the modulator using the laser beam, and timing the transceived signals using the position of the center point.

In a chat orbiter architecture, the primary orbiter 1104 is crucial to the overall system. The primary orbiter comprises a high-performance laser payload that acts as the central communication hub for the entire constellation of chat-orbiters 1102. As described herein The primary orbiter transmits laser signals to the chat-orbiters, which use MRRs to reflect these signals back. Example applications include remote sensing (e.g., of the atmosphere, magnetosphere, or surface of the Earth, planetary body, or stars). Some measurements (e.g., such as measurements of the magnetic field and plasma in the magnetosphere) benefit from simultaneous observations from multiple locations within the constellation of chat orbiters.

FIG. 11 illustrates a chat orbiter wherein optical communications can employ passive data transmission by utilizing a wide-angle retroreflector paired with an ultra-low power optical modulator, which effectively encodes data onto the reflected light beam [5]. Despite their minimal size and weight, chat-orbiters are equipped with the necessary instruments to gather data for remote sensing and can complement or add to the studies conducted by the primary orbiter. The Chat-orbiter is equipped with an MRR and instruments designed to perform remote sensing, all while maintaining a passive approach with no active attitude or trajectory control, hence no propulsion during the scientific measurements (it may still need certain attitude control and measurements between science measurements for attitude calibration purposes).

To effectively perform remote sensing, the Chat-orbiter must carry various instruments (e.g., magnetometer and additional plasma instruments, e.g., a fluxgate magnetometer and an electron/particle detector [7]).

Example power sources for the chat orbiter include, but are not limited to, a single battery system and/or solar panels (e.g., standalone or in combination with a batter to further enhance power management).

The compact (and in some embodiments, expendable) nature of the chat-orbiters further offers key advantages: their strategic deployment in divergent directions (e.g., in a space environment, atmosphere or magnetosphere) ensures extensive coverage and the capability to collect data from multiple locations simultaneously. Even if the chat orbiters spin, data retrieval remains feasible because the reflected signals are consistently received by the primary orbiter. Additionally, with multiple MRRs installed on the same chat-orbiter spacecraft, the rotation rate can be precisely determined by the retroreflected laser. This allows the chat orbiter to carry a single sensor (e.g., scalar sensor) to deduce the 3dimensional remote sensing (e.g., magnetic or electromagnetic field) information. An attitude sensor is still needed for an initial determination of the attitudes before the spinning starts. Then the sensor can be powered off and the attitudes can be calculated with the rotation rate measurement and the initial measurements.

### Communication Data Rate Analysis

The achievable data rate for communication between the Chat-orbiter and the main Orbiter can be simulated, taking into account the variable range between the two (i.e., the chat-orbiter moving away from the main orbiter at different ranges). This evaluation assumes a continuous line of sight between the laser and MRR on the CubeSat/chat-orbiter. Table 3 shows the calculated expected performance for a cat-eye MRR designed to operate at 1550 nm for remote sensing of a magnetosphere of a planet such as Uranus.

TABLE 3
Parameters Notation and Values

| Notation | Description | Value | |
|---|---|---|---|
| λ | Wavelength | 1550 | nm |
| DoM | Depth of modulation | 0.25 | |
| T | Transmittance | 0.8 | |
| NEP η_{optical} P₀ | Detector noise equivalent power Optical efficiency | $\begin{matrix}5 \times {10}^{- 12} \frac{W}{\sqrt{Hz}} \\ 0.8\end{matrix}$ | |
| M | Laser power | 10 | W |
| | Gaussian beam quality factor | 1 | |
| w₀ | Laser beam waist | 1 | mm |
| Dₜ | Optical lens aperture main orbiter | 100 | mm |
| DMRR | Optical lens aperture MRR | 25 | mm |
| B | Bandwidth | 100 | MHz |

These calculations assume a 10 W laser power on the main orbiter, a beam quality M=1 (Gaussian), and a Gaussian beam waist of 1 mm. The optical aperture is the lens diameter). The base data rate and subsequent calculations were from the following relations. The beam divergence is:

$$θ = \frac{{M}^{2} λ}{π {w}_{0}}$$

The beam radius at a distance r is:

$$w ( r ) = {w}_{0} \sqrt{1 + {( \frac{θ r}{2} )}^{2}}$$

The overlap factor is:

$$Y = \frac{min ( {A}_{L} , {A}_{R} )}{{A}_{L}}$$

where A_{L}=πw(r)² represents the laser illuminated area at a distance r, and

$${A}_{R} = {π ( \frac{D}{2} )}^{2}$$

represents the area of the receiver.

P=(Y_{tran2MRR}×Y_{MRR2tran}×ηoptical)·P0.

Then the received power P is calculated considering the factors Y_{tran2MRR} and Y_{MRR2tran}, which account for the attenuation of the laser beam from the transmitter to the MRR and from the MRR back to the transmitter, respectively. The received signal power, noise, and signal-to-noise are thus:

$${P}_{s} = T \cdot xDoM x \cdot P$$

$$N \sqrt{{( NEP )}^{2} \cdot B + ( \frac{2 hc}{λ} \cdot T \cdot B ) \cdot {P}_{0}}$$

$$SNR = \frac{{P}_{s}}{N}$$

Where h is the Planck constant and c is the speed of light. The data rate is:

$$DataRate = B x \cdot {log}_{2} ( 1 + SNR )$$

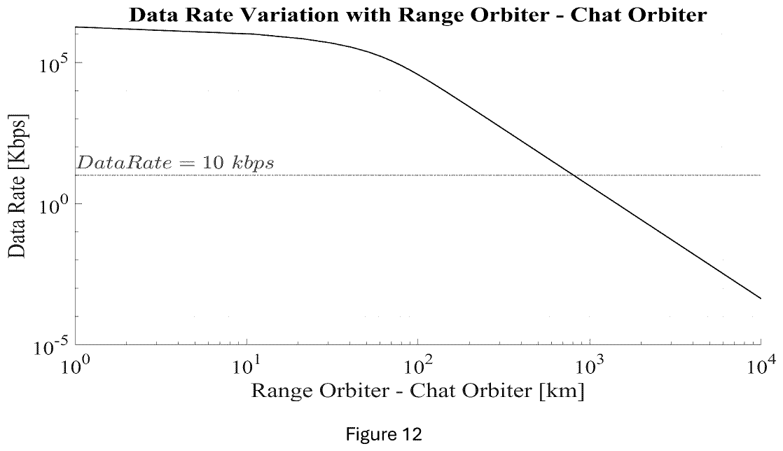

The evaluated data rate has been calculated for various ranges between the main orbiter and the Chat-orbiter using the parameters listed in Table 3. The results indicate that the data rate remains high enough to support the transmission of magnetometer data and plasma measurements up to approximately 1000 km, as shown in FIG. 12. Beyond this range, the data rate drops to around 10 kbps, beyond which it is assumed that acceptable data transmission cannot be maintained.

### Operational Lifetime Analysis

The operational lifetime analysis of the Chat-orbiter involves a detailed evaluation of its power consumption. To maintain simplicity, a single battery system is initially considered. In some embodiments, the chat-orbiters are fully charged by the primary orbiter before being released. The lifetime of each released chat-orbiter is limited by the on-board battery and the drift-away distance with the primary orbiter that prohibits meaningful data rates. The MRR, in particular, demonstrates exceptionally low power consumption, potentially as low as a few pJ/bit [3]. Sensors on board the orbiter can be flexible, lightweight, and low-power [8], [9], (describing an magnetometer operating with power consumption on the order of mW, and some optomechanical magnetometers exhibit very low power consumption, ranging from a few μW to a few mW while still exhibiting sensitivities in the nT to μT range). Other example sensors include particle detectors (e.g., Silicon Surface Barrier Detectors) using charge-sensitive preamplifiers that can achieve a power consumption of around 10 mW. An example power consumption calculation is as assumes an MRR with an energy consumption of E_{MRR}=2.76·10⁻¹⁰ J/bit, and the total power consumption of the sensors (in this simulation magnetosphere instruments) P_{mag}, varying between 5 mW and 1 W in total.

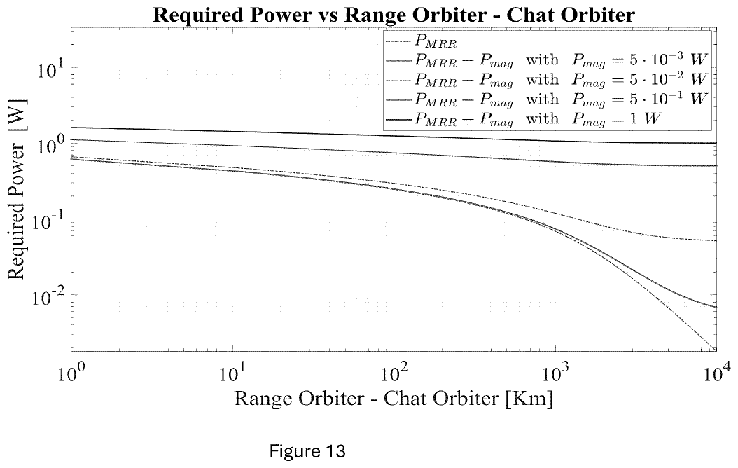

The power consumption of the MRR depends on the range between the Chat-orbiter and the main orbiter, as different distances result in varying data rates and consequently different power consumption. Each Chatorbiter continuously collects data and passively transmits it immediately whenever it is within the line-of-sight of the main orbiter, with power consumption depending on the range and P_{MRR}=E_{MRR}·DataRate. This is illustrated in FIG. 13 showing power consumption as a function of the distance from the main orbiter for different cases of Pmag.

Table 4 shows a battery life of the order of days is feasible, assuming the battery has a capacity of 150 Wh (a common choice for many CubeSats) and accounting for the variable range of the Chat-orbiter throughout the mission.

The first scenario analyzes represents the maximum power consumption, occurring when the Chat-orbiter is closest to the main orbiter. In this case, the reduced distance results in a higher data rate and increased power consumption. However, this is an exceptional worst case scenario. The second scenario considers average power consumption, calculated as the mean of the values across all range distances. The battery life analysis reveals that the operational duration extends to 80 to 200 days when the power consumption of the sensors (e.g., magnetosphere instruments) ranges between a few mW and 50 mW. Even assuming a higher power consumption scenario (1 W), measurements could still be feasible over several days.

Solar panels can also be used to power the Chatorbiter. Considering a CubeSat with each face measuring 20 cm×20 cm and a typical solar panel efficiency of 150 W/m, approximately 22 mW per face could be generated at a distance as far as Uranus.

The power availability and battery lifetime analysis above can be used to select appropriate sensors and orbiter trajectories.

TABLE 4
Battery Duration Values

| | Battery Duration | | | |
|---|---|---|---|---|
| Power Required | Maximum P_{MRR} | | Average P_{MRR} | |
| PMRR = 5 · 10⁻³ W + Pmag, | 10.1 | days | 206.7 | days |
| with Pmag | | | | |
| PMRR = 5 · 10⁻² W + Pmag, | 9.5 | days | 83.1 | days |
| with Pmag | | | | |
| PMRR = 5 · 10⁻¹ W + Pmag, | 5.6 | days | 11.9 | days |
| with Pmag | | | | |
| PMRR + Pmag, with Pmag = | 3.9 | days | 6.1 | days |
| 1 W | | | | |

Chatorbiter components can also be selected according to the operation thermal environment, which is a another critical contributor to operational lifetime. Some spaceborne applications may require operation at low temperatures. Both MRRs and sensors are designed to operate in cryogenic to low-temperature conditions, and Lithium-Thionyl Chloride and Lithium-Sulfur batteries are among those capable of operating at low temperatures, typically ranging from −80° C. to −20° C. However, reliability of the battery system under in space remains a concern. Therefore, insulation can be provided for the Cubesat to protect the battery or other components against degradation. The required thickness of insulation for a CubeSat can be determined using Fourier's law:

$$Q = \frac{k \cdot A \cdot Δ T}{d}$$

where Q: The heat transfer, k is Thermal conductivity of the insulating material, A is the surface area through which heat is transferred, d: The thickness of the insulating material.

For a CubeSat operating in a vacuum (primary heat transfer is radiation) with external cryogenic temperatures around −223.15° C. and an internal temperature target of −50° C., achieving practical and thin insulation thicknesses becomes challenging. For some applications, advanced insulation systems such as Vacuum Insulation Panels (VIP) and Multilayer Insulation (MLI) face can be used. For other applications where the insulation thicknesses would be too large for the limited surface area of a CubeSat (20 cm×20 cm per face), insulation can be combined with Phase Change Materials (PCMs) and low-melting-point metal alloys to manage internal temperatures by releasing heat or withstanding extreme cold conditions. In other applications, membrane-based thermal micro-exchangers or resistive heaters can be combined with the insulation materials to provide precise temperature control while consuming minimal power. Using these materials and technologies together can address both the thickness and thermal management challenges, ensuring that the CubeSat maintains the desired internal temperature.

### Experimental Results

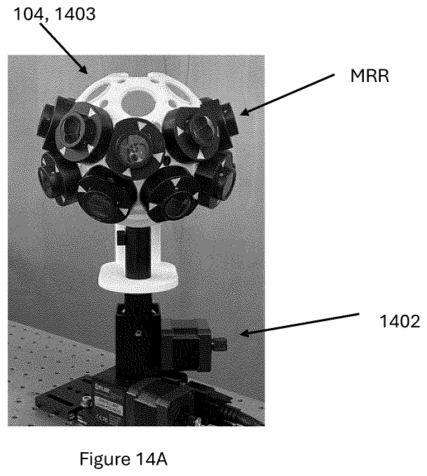

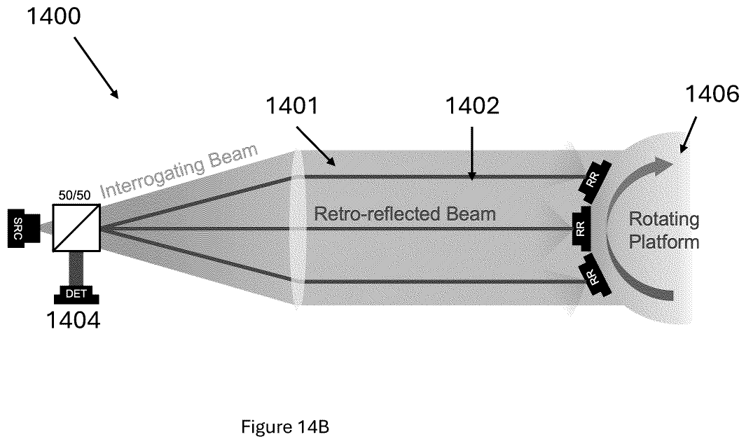

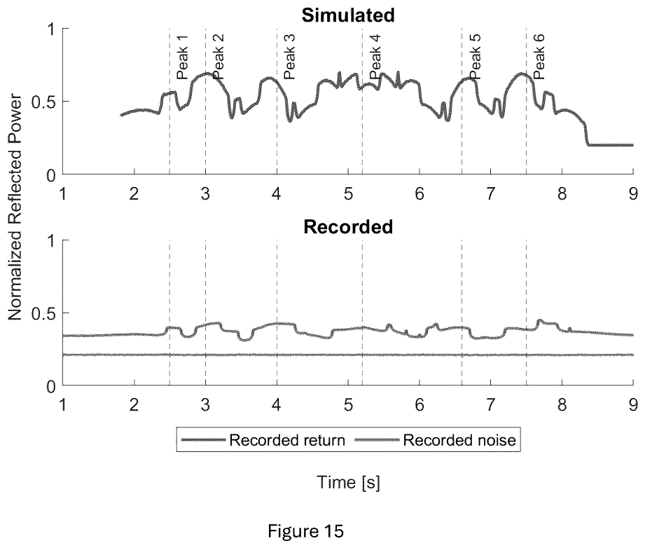

Simulation work described herein shows it should be possible for a well-oriented array of retroreflectors to successfully maintain an optical link with the interrogating transceiver at any or almost any angle with respect to the primary orbiter. Experiments were performed on a rotating testbed to show validate the simulation, whosing that a spinning chat-orbiter/unmanned vehicle/satellite can maintain an effective (e.g., optical) communications link with the primary base station even when spinning. FIG. 14A shows individual modulating retroreflectors MRR (corner cube reflectors) with an approximate FOV of 30 deg placed on an icosahedral base 1403 and the icosahedral base mounted on a gimbal 1402 (capable of travel at up to 51 deg/s). During spinning of the base, the received signal power was recorded using a double-pass setup 1400 as illustrated in FIG. 14B. Specifically, a broad collimated beam 1401 was projected onto the model on the rotating platform 1406 and the return power of the retroreflected beam 1402 from retroreflectors RR was recorded using a detector (DET) 1404 during a near full (300 deg) rotation. The result of the experiment (FIG. 15) showed that an optical link is established at all times, irrespective of angle, but that the return power does vary based on the number of retroreflectors properly illuminated at any given time or point in rotation. Using the more consistent placement of retroreflectors, as compared to the existing model but still in an icosahedral pattern, it is likely that constant illumination at any rotation and angle is possible. Artifacts due to inconsistent reflections at corner cube edges can be corrected. Additionally, the use of a communications protocol that can accommodate for gaps in signal during the rotation may also be considered and thus a full 4π steradian coverage angle may not be necessary. Therefore experimental work confirms the possibilty of a continuous optical link and enablement of arrays small spinning platforms-even without a continuous link.

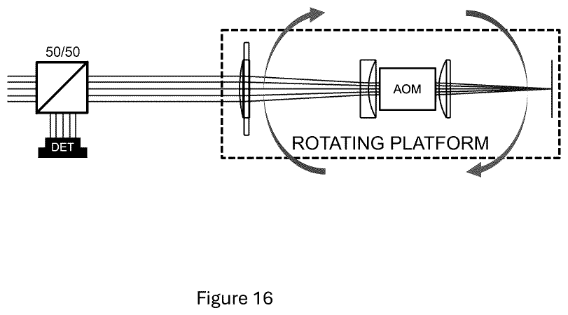

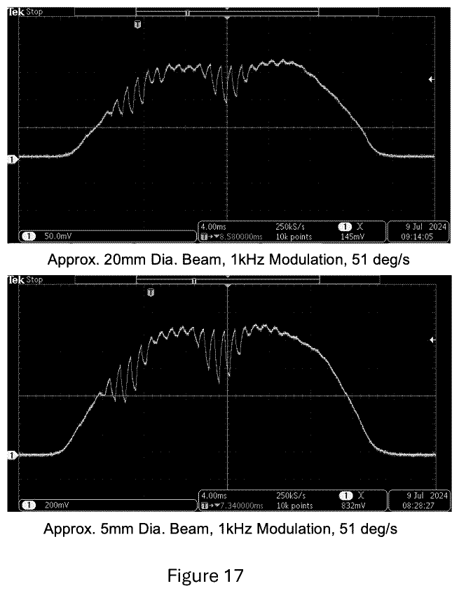

A similar double-pass setup as illustrated in FIG. 16 was used to establish the feasibility of transmitting data from an MRR platform during spinning operation. The MRR itself relied on modulating the reflected signal via an acousto-optic modulator (AOM). A single, telecentric lens setup was utilized to focus the interrogating beam into the narrow aperture of the AOM, which was then retro-reflected using a cat-eye architecture. The use of an AOM places significant limitations on the operation of the system, as the modulation depth is affected by the incoming beam's power density and alignment through the internal crystal. Due to these effects, the data transmission setup had a retro-reflecting FOV of approximately 1.2 deg, and an input aperture size of 1 inch. Using an interrogating beam expanded to both 5 mm and 20 mm diameters, the return signal was recorded while rotating the platform at 51 deg/s with an AOM modulation rate of 1 kHz. Based on the collected data (FIG. 17), we found that the returned signal varies in modulation depth over the course of the rotation, with the entire signal fading in a roughly normal format near the edge of the MRR's FOV. Despite this, the 1 kHz signal can still be clearly denoted. It is likely that the relatively slow modulation speed and varying modulation depth arose from the use of the AOM, which could not provide consistent modulation at higher frequencies due to the changing power densities present throughout the rotation. This is not expected to be an issue for embodiments using the quantum well modulators (QWMs).

### Hardware Environment

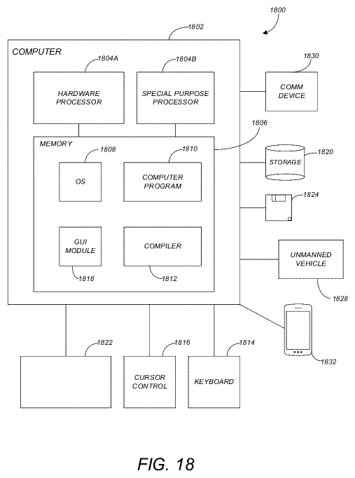

FIG. 18 is an exemplary hardware and software environment 1800 (referred to as a computer-implemented system and/or computer-implemented method) used to implement one or more embodiments described herein (e.g., control of the systems described herein and timing algorithms for synchronizing the unmanned vehicles 1828). The hardware and software environment includes a computer 1802 and may include peripherals. Computer 1802 may be a user/client computer, server computer, or may be a database computer. The computer 1802 comprises a hardware processor 1804A and/or a special purpose hardware processor 1804B (hereinafter alternatively collectively referred to as processor 1804) and a memory 1806, such as random access memory (RAM). The computer 1802 may be coupled to, and/or integrated with, other devices, including input/output (I/O) devices such as a keyboard 1814, a cursor control device 1816 (e.g., a mouse, a pointing device, pen and tablet, touch screen, multi-touch device, etc.). In one or more embodiments, computer 1802 may be coupled to, or may comprise, a portable or media viewing/listening device 1832 (e.g., cellular device, personal digital assistant, etc.). In yet another embodiment, the computer 1802 may comprise a multi-touch device, mobile phone, or other internet enabled device executing on various platforms and operating systems.

In one embodiment, the computer 1802 operates by the hardware processor 1804A performing instructions defined by the computer program 1810 (e.g., a control or remote sensing or communication application) under control of an operating system 1808. The computer program 1810 and/or the operating system 1808 may be stored in the memory 1806 and may interface with the user and/or other devices to accept input and commands and, based on such input and commands and the instructions defined by the computer program 1810 and operating system 1808, to provide output and results.

Output/results may be presented on the display 1822 or provided to another device for presentation or further processing or action. The image may be provided through a graphical user interface (GUI) module 1818. Although the GUI module 1818 is depicted as a separate module, the instructions performing the GUI functions can be resident or distributed in the operating system 1808, the computer program 1810, or implemented with special purpose memory and processors.

Some or all of the operations performed by the computer 1802 according to the computer program 1810 instructions may be implemented in a special purpose processor 1804B. In this embodiment, some or all of the computer program 1810 instructions may be implemented via firmware instructions stored in a read only memory (ROM), a programmable read only memory (PROM) or flash memory within the special purpose processor 1804B or in memory 1806. The special purpose processor 1804B may also be hardwired through circuit design to perform some or all of the operations to implement the present invention. Further, the special purpose processor 1804B may be a hybrid processor, which includes dedicated circuitry for performing a subset of functions, and other circuits for performing more general functions such as responding to computer program 1810 instructions. In one embodiment, the special purpose processor 1804B is an application specific integrated circuit (ASIC), field programmable gate array (FPGA), graphics processing unit (GPU), or artificial intelligence or machine learning processor.

The computer 1802 may also implement a compiler 1812 that allows an application or computer program 1810 written in a programming language such as C, C++, Assembly, SQL, PYTHON, PROLOG, MATLAB, RUBY, RAILS, HASKELL, or other language to be translated into processor 1804 readable code. Alternatively, the compiler 1812 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1810 accesses and manipulates data accepted from I/O devices and stored in the memory 1806 of the computer 1802 using the relationships and logic that were generated using the compiler 1812.

The computer 1802 also optionally comprises an external communication device such as a modem, satellite link, Ethernet card, or other device for accepting input from, and providing output to, other computers 1802.

In one embodiment, instructions implementing the operating system 1808, the computer program 1810, and the compiler 1812 are tangibly embodied in a non-transitory computer-readable medium, e.g., data storage device 1820, which could include one or more fixed or removable data storage devices, such as a zip drive, floppy disc drive 1824, hard drive, CD-ROM drive, tape drive, etc. Further, the operating system 1808 and the computer program 1810 are comprised of computer program 1810 instructions which, when accessed, read and executed by the computer 1802, cause the computer 1802 to perform the steps necessary to implement and/or use the present invention or to load the program of instructions into a memory 1806, thus creating a special purpose data structure causing the computer 1802 to operate as a specially programmed computer executing the method steps described herein. Computer program 1810 and/or operating instructions may also be tangibly embodied in memory 1806 and/or data communications devices 1830, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1802.

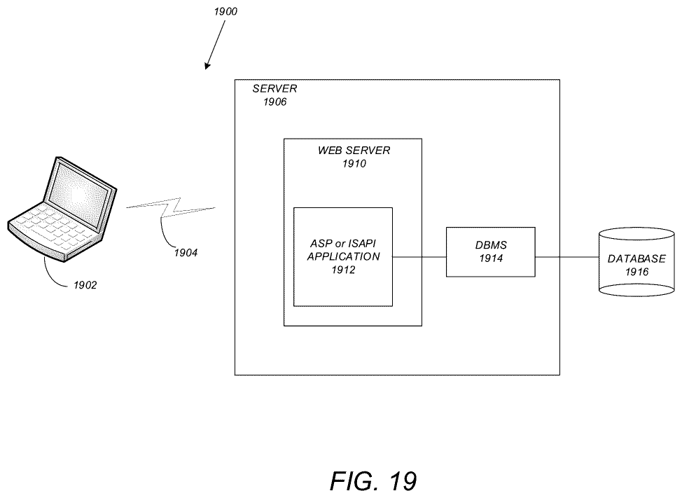

FIG. 19 schematically illustrates a typical distributed/cloud-based computer system 1900 using a network 1904 to connect client computers 1902 to server computers 1906. A typical combination of resources may include a network 1904 comprising the Internet, LANs (local area networks), WANs (wide area networks), SNA (systems network architecture) networks, or the like, clients 1902 that are personal computers or workstations (as set forth in FIG. 18), and servers 1906 that are personal computers, workstations, minicomputers, or mainframes (as set forth in FIG. 18). However, it may be noted that different networks such as a cellular network (e.g., GSM [global system for mobile communications] or otherwise), a satellite based network, or any other type of network may be used to connect clients 1902 and servers 1906 in accordance with embodiments of the invention.

A network 1904 such as the Internet connects clients 1902 to server computers 1906. Network 1904 may utilize ethernet, coaxial cable, wireless communications, radio frequency (RF), etc. to connect and provide the communication between clients 1902 and servers 1906. Further, in a cloud-based computing system, resources (e.g., storage, processors, applications, memory, infrastructure, etc.) in clients 1902 and server computers 1906 may be shared by clients 1902, server computers 1906, and users across one or more networks. Resources may be shared by multiple users and can be dynamically reallocated per demand. In this regard, cloud computing may be referred to as a model for enabling access to a shared pool of configurable computing resources.

Clients 1902 may execute a client application or web browser and communicate with server computers 1906 executing web servers 1910. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 1902 may be downloaded from server computer 1906 to client computers 1902 and installed as a plug-in or ACTIVEX control of a web browser. Accordingly, clients 1902 may utilize ACTIVEX components/component object model (COM) or distributed COM (DCOM) components to provide a user interface on a display of client 1902. The web server 1910 is typically a program such as MICROSOFT'S INTERNET INFORMATION SERVER.

Web server 1910 may host an Active Server Page (ASP) or Internet Server Application Programming Interface (ISAPI) application 1912, which may be executing scripts. The scripts invoke objects that execute business logic (referred to as business objects). The business objects then manipulate data in database 1916 through a database management system (DBMS) 1914. Alternatively, database 1916 may be part of, or connected directly to, client 1902 instead of communicating/obtaining the information from database 1916 across network 1904. When a developer encapsulates the business functionality into objects, the system may be referred to as a component object model (COM) system. Accordingly, the scripts executing on web server 1910 (and/or application 1912) invoke COM objects that implement the business logic. Further, server 1906 may utilize MICROSOFT'S TRANSACTION SERVER (MTS) to access required data stored in database 1916 via an interface such as ADO (Active Data Objects), OLE DB (Object Linking and Embedding DataBase), or ODBC (Open DataBase Connectivity).

Generally, these components 1900-1916 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 1902 and 1906 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 1902 and 1906. Embodiments of the invention are implemented as a software application on a client 1902 or server computer 1906. Further, as described above, the client 1902 or server computer 1906 may comprise a thin client device or a portable device that has a multi-touch-based display.

### Process Steps

### Method of Assembly

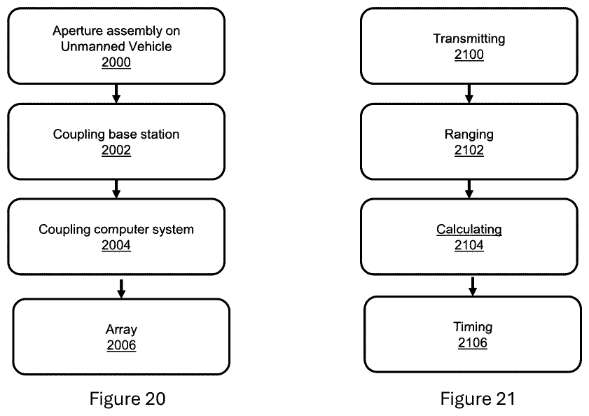

FIG. 20 illustrates a method of making a system (e.g., communication or remote sensing system), unmanned vehicle, or aperture.

Block 2000 represents fabricating or obtaining a plurality of unmanned vehicles attached to an optical receiver for modulating a ranging laser beam and a transceiver for transmitting and/or receiving signals. The optical receiver comprises an optical aperture comprising a plurality of modulating retroreflectors (MRRs) disposed at a same radius about a center point of the optical aperture, and each of the modulating retroreflectors comprises a plurality of reflectors coupled to a modulator. The optical receiver further comprises an electronic circuit for driving the modulator on different ones of the unmanned vehicles to impart a unique modulation to the beam that allows identification of the center point on the different UAVs by the ranging measurement.

Block 2002 represents coupling the unmanned vehicles to one or more base stations.

Block 2004 represents coupling the base station to a computer system programmed for calculating the position of the center point from a ranging measurement of a coordinate of the modulator using the laser beam, and timing the signal using the position of the center point.

Block 2006 represents the end result, a system or array or device.

The system, aperture, or unmanned vehicle can be embodied in many ways, including but not limited to, the following (referring to FIGS. 1-19).
1. A system comprising a plurality of unmanned vehicles each attached to: an optical receiver comprising an optical aperture comprising a plurality of modulating retroreflectors (MRRs) disposed at a same radius about a center point of the optical aperture, wherein each of the modulating retroreflectors comprises a plurality of reflectors coupled to a modulator; a transceiver for a signal; one or more base stations, each of the base stations comprising a base transceiver a transmitter comprising a laser for transmitting a laser beam having a size irradiating the unmanned vehicles, and a receiver for receiving a modulated reflection of the laser beam from one or more of the MRRs; and a computer programmed for calculating the position of the center point from a ranging measurement of a coordinate of the modulator using the laser beam, and timing the signal using the position of the center point.
2. The system of clause 1, wherein the position of the center point is determined with an accuracy within 1/15 of the operating wavelength of electromagnetic radiation having a wavelength in a range of 0.1 to 20 GHz and/or with the accuracy that allows picosecond timing synchronisation of signals transmitted from the unmanned vehicles.
3. The system of clause 1 or 2, wherein the computer determines the position of the center point from a change in the coordinate of the modulator as the modulator rotates.
4. The system of any of the clauses 1-3, wherein the optical receiver comprises an electronic circuit for driving the modulator on different ones of the unmanned vehicles to impart a unique modulation to the beam that allows identification of the center point on the different unmanned vehicles by the ranging measurement.
5. The system of any of the clauses 1-4 comprising at least 4 of the base stations comprising ground stations each positioned to irradiate all of the unmanned vehicles with the laser beam, wherein the computer determines a 4D coordinate (3 spatial coordinates and one time coordinate) from the coordinate obtained using the laser beam transmitted from each of ground stations, or at least 3 of the base stations comprising ground stations each positioned to irradiate all of the unmanned vehicles with the laser beam, wherein the computer determines a 3D coordinate (e.g., comprising 3 spatial coordinates x, y, z) from the coordinate obtained using the laser beam transmitted from each of ground stations,
6. A device, comprising an optical aperture comprising a plurality of outwardly facing modulating retroreflectors (MRR) disposed at a same radius about a center point; wherein each of the MRRs comprises a plurality of reflectors coupled to a modulator, and a number and arrangement of the reflectors is configured to enable positioning of the aperture from a ranging measurement of a coordinate of the modulator using retroreflections of laser beams back to at least one base station after transmission from the at least one base station and when the aperture is attached to an airborne or spaceborne unmanned vehicle.
7. The system or aperture of any of the clauses 1-6, wherein the modulator comprises a stepped quantum well.
8. The system or aperture of any of the clauses 1-7 wherein the MRRs are disposed an the surface of the optical aperture shaped as an octahedron or icosahedron comprising facets disposed about the center point, wherein the facets comprise subdivisions 222 including the reflectors 202.
9. The system or aperture of any of the clauses 1-8 wherein the MRRs are disposed an the surface of the optical aperture shaped as a geoedesic polyhedron (e.g. octahedron or icosahedron) comprising facets disposed about the center point 214, wherein the facets comprise subdivisions 222 and the number of subdivisions comprising reflectors 202 of an MRR are tailored for a predetermined data rate or robustness in terms of reliability in reflecting the laser beam.
10. The device or system of any of the clauses 1-9, wherein the optical aperture comprises a geodesic polyhedron (e.g., octahedron or icosahedron) or section thereof and the reflectors are disposed on facets of the polyhedron or subdivisions thereof.
11. The device or system of any of the clauses 1-10, wherein the geodesic polyhedron comprises a 3D printed polymer framework supporting the reflectors mounted on the framework.
12. The device or system of any of the clauses 1-11, comprising the vehicle comprising a satellite (e.g., CubeSat or nanosat) or drone further comprising a transceiver.
13. The system or aperture of any of the clauses 1-12 wherein the MRRs comprise corner reflectors or cats eyes.
14. The device or system of any of the clauses 1-13, wherein the number and the arrangement of the reflectors such that a view factor, defined as fraction of time any of the MRRs of the vehicle retroreflects the laser beams back to the at least one base station, is at least 50%.
15. The device or system of any of the clauses 1-14 wherein the number and the arrangement of the retroreflectors are such that a data rate of the transmission is at least 3 Mbps per square centimeter of each of the unmanned vehicles.
16. A computer implemented method of synchronizing a plurality of unmanned vehicles, comprising controlling transmission, from one or more base stations, of a laser beam to a plurality of apertures each comprising a plurality of modulated retroreflectors (MRRs), each of the apertures mounted to a different one a plurality of unmanned vehicles that are airborne or spaceborne; performing a ranging measurement of a coordinate of the MRRs using a retroflection of the laser beam from the MRRs; calculating a position of the aperture from the coordinate; and timing data signals received or transmitted from transceivers on the unmanned vehicles using the position of the aperture.
17. A computer system comprising (a) one or more computers having one or more memories; (b) one or more processors executing on the one or more computers; (c) the one or more memories storing one or more sets of instructions, wherein the one or more sets of instructions, when executed by the one or more processors cause the one or more processors to perform the functionality or instructions of any of the clauses 1-15.
18. A computer comprising a non-transitory computer readable medium storing a plurality of instructions, the plurality of instructions comprising the instructions or functionality of any of the clauses 1-15.
19. The system of any of the clauses 1-15 wherein the computer comprises the computer system or medium of clauses 17-18.
20. The system of any of the clauses 1-19, wherein the unmanned vehicles (e.g., UAVs) are positioned in swarm to create a large interferometric antenna, e.g., with frequency range 0.1 to 2 GHz.
21. The system of any of the clauses, wherein the timing using a synchronization algorithm: ensure that the unmanned vehicles (e.g., UAVs) execute functions at precisely synchronized intervals.
22. The system of any of the clauses 1-21, wherein the computer executes an algorithm to better determine the position of the center of the retroreflector in order to reduce the time synchronization error due to geometric variation of the MRRs.
23. The system of any of the clauses 1-22 configured for an application including disaster emergency communications, mobile/flexible array radar, satellite/plane-UAV direct communications, mass mobile-platforms clock synchronization, quantum networking with unmanned vehicle end nodes.
24. The system of any of the clauses 1-23 forming an interferometric array supporting up to 2 GHz carrier frequency with positioning error no more than 0.011 m.
25. The system of any of the clauses 1-23 configured as a passive optical wireless linking architecture.

### Method of Operation

FIG. 21 illustrates a method of operating a system (e.g., communication or remote sensing system).

Block 2100 represents using a computer system to control transmission, from one or more base stations, of a laser beam to a plurality of apertures each comprising a plurality of modulated retroreflectors (MRRs), each apertures mounted to a different one a plurality of unmanned vehicles that are airborne or spaceborne.

Block 2102 represents using the computer to perform a ranging measurement (e.g., LIDAR) of a coordinate of the MRRs using a retroflection of the laser beam from the MRRs.

Block 2102 represents using the computer to calculate, determine, or estimate a position of the aperture from the coordinate. The computer may comprise:
(a) one or more computers having one or more memories;
(b) one or more processors executing on the one or more computers;
(c) the one or more memories storing one or more sets of instructions, wherein the one or more sets of instructions, when executed by the one or more processors cause the one or more processors to perform

Block 2104 represents outputting timing signals from the computer system that are used to time data signals received or transmitted from the unmanned vehicles using the position of the center point.

Block 2106 represents optionally sending and/or receiving signals using the network of unmanned vehicles.

Embodiments include, but are not limited to, the following:

In one embodiment, data is transmitted from the base station to the unmanned vehicles using the laser beam as an uplink. Transceivers on the unmanned vehicles can either re-transmit data, other data based on the data, or perform other functionalities. In another embodiment, data is received on the transceiver of the unmanned vehicles and forwarded to the base station via the laser beam and MRRs as a downlink.

In one embodiment, the base station transmitter further comprises a base station modulator operable to modulate a carrier wave of the laser beam with a signal comprising data and/or timing information (e.g., for an up-link transmission); and the optical receiver further comprises a receiver circuit for detecting the laser beam and demodulating the signal in response to the detection of the laser beam; and an antenna 116 (or other transceiver aperture) for transmitting an electromagnetic field 120 (e.g., RF field) with the signal demodulated from the laser beam.

The receiver circuit on the unmanned vehicle may also demodulate or otherwise process a received signal from an electromagnetic field received on the transceiver aperture (e.g., comprising antenna 116 or sensor or detector), and then modulate the carrier wave of the laser beam with the received modulation signal via the modulator in the MRR (down-link transmission). The base station demodulator may then demodulate the received signal from the retroreflected laser beam. The received signal may comprise remote sensing signal or communication signal, for example.

The method can be implemented using the system or device of any of the clauses 1-25 in paragraphs 135-159 above, for example.

### Algorithm for Calculating Position

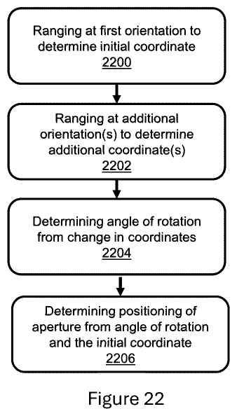

FIG. 22 illustrates a computer implemented method for determining the position of the center point from a change in the coordinate of the modulator as the modulator rotates. The computer is programmed to calculate the center position of the aperture on each of a plurality of the unmanned vehicles by executing an algorithm comprising the following steps.

Block 2200 represents, for a first orientation of the modulator, performing the ranging measurement of a distance traveled by the laser beam through a channel defined by one of the MRRs coupled to the modulator; and determining the coordinate, comprising an initial coordinate of the modulator relative the center point, from the distance, an angle at which the beam is transmitted from the base station, and location coordinate of the base station.

Block 2202 represents, for at least one additional orientation of the modulator, performing the ranging measurement to determine the coordinate comprising at least one additional coordinate of the modulator.

Block 2204 represents, for the at least one additional orientation, determining an angle of rotation of the modulator by comparing the initial coordinate and the at least one additional coordinate.

Block 2206 represents, for the at least one additional orientation, determining the position of center point from the angle of rotation and the initial coordinate of the modulator.

In some embodiments, the computer calculates the distance traveled by the laser beam for a plurality of the channels and the determines the coordinate as the average measurement for the plurality of the channels.

In one more embodiments, the ranging measurements determine the coordinate of the modulator using:

$$\vec{{p}_{ι}} = \vec{{p}_{g}} + \frac{d - {r}_{i}}{2} [ cos ( θ ) , sin ( θ ) ]$$

where \vec{pᵢ} represents the estimated position of the modulator, \vec{p_{g}} is the position of the ground station, d is the total distance traveled by the laser beam, rᵢ is the average distance the laser beam travels in the i^{th} MRR channel, and θ is the angle at which the laser beam is transmitted, and
the computer estimates the center position of the modulator using

$${c}_{i} = {p}_{i} + {s}_{i} [ cos ( {ϕ}_{i} + Φ ) , sin ( {ϕ}_{i} + Φ ) ]$$

where cᵢ is the estimated center position of the retroreflector based on the i^{th} modulator, \vec{p}ᵢ is the estimated position of the modulator, sᵢ is the distance between the i^{th} modulator retroreflector and the center of the retroreflector, ϕ is the angle of elevation from the i^{th} retroreflector to the center of the retroreflector in an initial state, and Φ is the angle of rotation of the retroreflector.

The method can be implemented using the system or device of any of the clauses The method can be implemented using the system or device of any of the clauses 1-25 in paragraphs 135-159 above, for example.

### Advantages and Improvements

In one embodiment, a mission concept involves forming a low-cost, fast-implementation large communication antenna using UAVs and a few laser ground terminals. At frequencies of 0.1 to 20 GHz, it is challenging to directly use GNSS signal to provide real-time feedback and data processing of such interferometric antenna. Taking advantage of the fast advances of the quantum-well modulating retroreflecting with very low power consumption, such implementation is promising and may have wide applications, such as emergency communication in natural disasters that lack basic communication infrastructure. We present here a detailed study and time synchronization, including high-precision positioning and attitude measurements enabled by the modulating retroreflecting links.

We have shown that with the specifically designed MRR-based optical apertures, the geometric ranging/timing errors can be maintained as 1.1 cm for the 6-face, 0.1 m apothem aperture design (FIG. 4, indicating a time synchronization error is ˜37 ps caused by the uncontrollable geometric errors due to the dynamic motions of the UAVs), which can support a maximum operating frequency of 1.9 GHz for the interferometric antenna array. A much smaller geometric positioning error can be achieved with the 60-face optical aperture design with the same apothem. The corresponding timing error is expected to be much smaller than other errors, such as electronic delays, atmosphere delays, etc. When considering a picosecond overall timing synchronization, the antenna can provide an operating frequency as high as 20 GHz. We also provide the data rate and angular coverage trade-off analysis with different MRR supporting structures. Our designed optical apertures support a 10-40 Mbps data rate per UAV with common ground laser station parameters and distance to the UAV swarm.

### REFERENCES FOR SYSTEM EMBODIMENT (WITH GROUND STATIONS STARTING PARAGRAPH 47) AND WHICH REFERENCES ARE INCORPORATED BY REFERENCE HEREIN

The following references are incorporated by reference herein
[1] J. A. Nanzer, R. L. Schmid, T. M. Comberiate and J. E. Hodkin, “Open-Loop Coherent Distributed Arrays,” in IEEE Transactions on Microwave Theory and Techniques, vol. 65, no. 5, pp. 1662-1672 May 2017, doi: 10.1109/TMTT.2016.2637899.\
[2] S. M. Ellison and J. A. Nanzer, “High-Accuracy Multinode Ranging For Coherent Distributed Antenna Arrays,” in IEEE Transactions on Aerospace and Electronic Systems, vol. 56, no. 5, pp. 4056-466 October 2020, doi: 10.1109/TAES.2020.2985251.
[3] Wheaton, S., Lopez-Dominguez, V., Almasi, H. et al. A 3 pJ/bit free space bit optical interlink platform for self-powered tetherless sensing and opto-spintronic RF-to-optical transduction. Sci Rep 11, 8504 (2021). https://doi org/10.1038/841598-021-87888-6
[4] Peter, G. Goetz, et al. “Modulating retro-reflector lasercom systems at the Naval Research Laboratory.” 2010-MILCOM 2010 MILITARY COMMUNICATIONS CONFERENCE. IEEE, 2010.
[5] Subrahmanya V. Bhide et al., “Passive Optical Links Supporting Spaceborne Low Radio Frequency Interferometric Telescope.” accepted in 2024 IEEE Aerospace Conference.

### REFERENCES FOR CHATORBITER EMBODIMENT STARTING PAGE 80 (WHICH REFERENCES ARE INCORPORATED BY REFERENCE HEREIN)

[1] E. National Academies of Sciences, Medicine et al., “Origins, worlds, and life: a decadal strategy for planetary science and astrobiology 2023-2032,” 2022
[2] M. T. Dabiri, M. Rezaee, L. Mohammadi, F. Javaherian, V. Yazdanian, M. O. Hasna, and M. Uysal, “Modulating retroreflector based free space optical link for uav-to ground communications,” IEEE Transactions on Wireless Communications, vol. 21, no. 10, pp. 8631-8645, 2022.
[3] S. Bianconi, S. Wheaton, M.-S. Park, I. H. Nia, and H. Mohseni, “Machine learning optimization of surface normal optical modulators for swir time-of-flight 3-d camera,” IEEE Journal of Selected Topics in Quantum Electronics, vol. 24, no. 6, pp. 1-8, 2018.
[4] J. Schumacher, S. V. Bhide, and L. Yi, “Timing synchronization among uavs swarm via quantum-well modulating retroreflecting optical communication for distributed interferometric antenna,” in Proceedings of the 55th Annual Precise Time and Time Interval Systems and Applications Meeting, 2024, pp. 117-126.
[5] G. G. Peter, S. R. William, R. Mahon, L. M. James, S. F. Mike, R. S. Michele, R. S. Walter, B. X. Ben, R. B. Harris, I. M. Christopher et al., “Modulating retro-reflector lasercom systems at the naval research laboratory,” in 2010-MILCOM 2010 MILITARY COMMUNICATIONS CONFERENCE. IEEE, 2010, pp. 1601-1606.
[6] S. Wheaton, V. Lopez-Dominguez, H. Almasi, J. Cai, Z. Zeng, P. Khalili Amiri, and H. Mohseni, “A 3 pj/bit free space optical interlink platform for selfpowered tetherless sensing and opto-spintronic rf-tooptical transduction,” Scientific reports, vol. 11, no. 1, p. 8504, 2021.
[7] V. Angelopoulos, E. Tsai, L. Bingley, C. Shaffer, D. Turner, A. Runov, W. Li, J. Liu, A. Artemyev, X.-J. Zhang et al., “The elfin mission,” Space science reviews, vol. 216, pp. 1-45, 2020.
[8] L. Regoli, M. Moldwin, J. Thoma, M. Pellioni, and B. Bronner, “Four-magnetometer board for cubesat applications,” 2018.
[9] E. Zesta, “A complete cubesat magnetometer system project,” Tech. Rep., 2014.
[10] J. S. Bennett, B. E. Vyhnalek, H. Greenall, E. M. Bridge, F. Gotardo, S. Forstner, G. I. Harris, F. A. Miranda, and W. P. Bowen, “Precision magnetometers for aerospace applications: A review,” Sensors, vol. 21, no. 16, p. 5568, 2021.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system, comprising:
a plurality of unmanned vehicles each attached to:
an optical receiver comprising an optical aperture comprising a plurality of modulating retroreflectors (MRRs) disposed at a same radius about a center point of the optical aperture, wherein each of the modulating retroreflectors comprises a plurality of reflectors coupled to a modulator; and
a transceiver for a signal;
one or more base stations, each of the base stations comprising a base transceiver:
a transmitter comprising a laser for transmitting a laser beam having a size irradiating the unmanned vehicles, and
a receiver for receiving a modulated reflection of the laser beam from one or more of the MRRs; and
a computer programmed for:
calculating the position of the center point from a ranging measurement of a coordinate of the modulator using the laser beam, and
timing the signal using the position of the center point.

2. The system of claim 1, wherein the position of the center point is determined with an accuracy within 1/15 of the operating wavelength of electromagnetic radiation having a wavelength in a range of 0.1 to 20 GHz and/or with the accuracy that allows picosecond timing synchronisation of signals transmitted from the unmanned vehicles.

3. The system of claim 1, wherein the computer determines the position of the center point from a change in the coordinate of the modulator as the modulator rotates.

4. The system of claim 1, wherein the computer calculates the center position on each of a plurality of the unmanned vehicles by executing an algorithm comprising:
for a first orientation of the modulator:
performing the ranging measurement of a distance traveled by the laser beam through a channel defined by one of the MRRs coupled to the modulator, and
determining the coordinate, comprising an initial coordinate of the modulator relative the center point, from the distance, an angle at which the beam is transmitted from the base station, and location coordinate of the base station, and
for at least one additional orientation of the modulator, performing the ranging measurement to determine the coordinate comprising at least one additional coordinate of the modulator,
determining an angle of rotation of the modulator by comparing the initial coordinate and the at least one additional coordinate; and
determining the position of center point from the angle of rotation and the initial coordinate of the modulator.

5. The system of claim 4, wherein the computer calculates the distance for a plurality of the channels and the determines the coordinate as the average measurement for the plurality of the channels.

6. The system of claim 1, wherein the optical receiver comprises an electronic circuit for driving the modulator on different ones of the unmanned vehicles to impart a unique modulation to the beam that allows identification of the center point on the different unmanned vehicles by the ranging measurement.

7. The system of claim 1 comprising at least 4 of the base stations comprising ground stations each positioned to irradiate all of the unmanned vehicles with the laser beam, wherein the computer determines a 4D coordinate (3 spatial coordinates and one time coordinate) from the coordinate obtained using the laser beam transmitted from each of ground stations.

8. The system of claim 1, wherein the MRRs are disposed an the surface of the optical aperture shaped as an octahedron comprising facets disposed about the center point, wherein the facets comprise subdivisions including the reflectors.

9. The system of claim 1, wherein the MRRs are disposed on the surface of the optical aperture shaped as an icosahedron comprising facets disposed about the center point, wherein the facets comprise one or more subdivisions including the reflectors.

10. The system of claim 1, wherein the MRRs are disposed an the surface of the optical aperture shaped as an octahedron or icosahedron comprising facets disposed about the center point, wherein the facets comprise subdivisions and the number of subdivisions are tailored for a predetermined data rate or robustness in terms of reliability in reflecting the laser beam.

11. The system of claim 1, wherein the modulator comprises a stepped quantum well.

12. The system of claim 1, wherein:
the transmitter further comprises a base station modulator operable to modulate a carrier wave of the laser beam with a data signal comprising data and/or timing information;
the optical receiver further comprises a circuit coupled to a transceiver aperture for:
demodulating the data signal in response to detection of the laser beam and modulating an electromagnetic field according to the data signal for transmission using the transceiver aperture; and/or
demodulating a received signal from an electromagnetic field received on the transceiver aperture and modulating the carrier wave of the laser beam with the received signal via the modulator in the MRR.

13. The system of claim 1 configured as:
a communication system wherein each of the unmanned vehicles comprise the transceiver comprising an antenna and the unmanned vehicles are disposed in an interferometric or phased array, wherein timing synchronizes the antennas in a phased array using the position of the center point, or
a remote sensing system wherein the unmanned vehicles each comprise the transceiver for the signal comprising a remote sensing signal, wherein the timing synchronizes the remote sensing signal.

14. A computer implemented method of synchronizing a plurality of unmanned vehicles, comprising:
controlling transmission, from one or more base stations, of a laser beam to a plurality of apertures each comprising a plurality of modulated retroreflectors (MRRs), each of the apertures mounted to a different one a plurality of unmanned vehicles that are airborne or spaceborne;
performing a ranging measurement of a coordinate of the MRRs using a retroflection of the laser beam from the MRRs;
calculating a position of the aperture from the coordinate; and
timing data signals received or transmitted from transceivers on the unmanned vehicles using the position of the aperture.

15. A device, comprising:
an optical aperture comprising a plurality of outwardly facing modulating retroreflectors (MRR) disposed at a same radius about a center point; wherein:
each of the MRRs comprises a plurality of reflectors coupled to a modulator, and
a number and arrangement of the reflectors is configured to enable positioning of the aperture from a ranging measurement of a coordinate of the modulator using retroreflections of laser beams back to at least one base station after transmission from the at least one base station and when the aperture is attached to an airborne or spaceborne unmanned vehicle.

16. The device of claim 15, wherein the number and the arrangement of the reflectors such that a view factor, defined as fraction of time any of the MRRs of the vehicle retroreflects the laser beams back to the at least one base station, is at least 50% or the number and the arrangement of the retroreflectors are such that a data rate of the transmission is at least 3 Mbps per square centimeter of each of the unmanned vehicles.

17. The device of claim 15, wherein the optical aperture comprises a geodesic polyhedron or section thereof and the reflectors are disposed on facets of the polyhedron or subdivisions thereof.

18. The device of claim 17, wherein the geodesic polyhedron comprises an octahedron or icosahedron.

19. The device of claim 17, wherein the geodesic polyhedron comprises a 3D printed polymer framework supporting the reflectors mounted on the framework.

20. The device of claim 15, comprising the vehicle comprising a satellite or drone further comprising a transceiver.
